(19) United States
(12) Patent Application Publication
(10) Pub. No.: US 2012/0090639 A1
(43) Pub. Date: Apr. 19, 2012

(54) SHIRLEY'S SOLUTIONS SYSTEMS

(76) Inventors: Leroy Heldman, Knoxville, TN (US); Andrew L. Heldman, Knoxville, TN (US); Timothy L. Heldman, Culleoka, TN (US); Patrick B. Heldman, Dothan, AL (US); Christine A. Bondy, Sterling, VA (US); Angela M. Palko, Knoxville, TN (US); Julia K. Brewster, Lenoir City, TN (US)

(21) Appl. No.: 13/236,612

(22) Filed: Sep. 19, 2011

Related U.S. Application Data
(60) Provisional application No. 61/393,428, filed on Oct. 15, 2010.

(51) Int. Cl. A47L 9/02; B08B 5/04

(52) U.S. Cl. 134/21; 15/246.2

(57) ABSTRACT

A vacuum cleaner attachment comprising an upper tubular elongated hollow member having a first open end and a second open end, a connector, and a lower elongated hollow member having a first end and a second end, the first end adapted to fit the connector. The first open end of the upper tubular elongated hollow member is adapted to connect to an end of a vacuum cleaner hose connected to a vacuum cleaner and the second open end of the upper tubular elongated hollow member is adapted to connect to the connector. The connector comprises an elbow attachment and connects the upper tubular elongated hollow member and the lower elongated hollow member The lower elongated hollow member comprises an elongated flattened rectangular profile having a bottom surface and a top surface, the bottom surface located adjacent a floor surface when a user is operating the vacuum cleaner.

### CROSS-REFERENCE TO RELATED APPLICATION

The present application is related to and claims priority from prior provisional application Ser. No. 61/393,428, filed Oct. 15, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of attachments for vacuum cleaner hoses and more specifically relates to an attachment for a vacuum cleaner hose adapted to clean inaccessible areas.

2. Description of the Related Art

Vacuum cleaning can be tiring and unpleasant. In addition to having to push and pull the oftentimes heavy and bulky vacuum cleaner, one has to move any obstructing items, such as chairs, couches, tables, television stands, etc. Since the lifting of furniture requires strength and agility, many people are simply not able or willing to lift up furniture, and subsequently do not vacuum clean properly underneath heavier and/or bulkier items. Therefore many users may be unable to clean their house properly.

Conventional vacuum cleaners may be able to fit only partially underneath heavier furniture, like couches, but they do not allow the user to properly clean the entire area beneath a couch or a bed, for example. Vacuum cleaner attachments are usually too short to help out in the household when it comes to larger, difficult to reach areas, and are usually designed to clean a smaller hard to reach area. Furthermore, moving furniture around the house, or bending so as to reach hard to reach areas underneath or on top of furniture, may result in frustration and injury.

Therefore a need exists for a reliable vacuum cleaner attachment, which may be attached to any vacuum cleaner hose, and which allows a user to effortlessly clean beneath and around furniture that is heavy and difficult to move. A need exists for a vacuum cleaner attachment that reduces the risk of household injuries caused by an attempt to move or maneuver around heavy and large items, and which makes vacuum cleaning an easier, more efficient, and more enjoyable task. Elderly people or people with reduced mobility or strength would particularly appreciate a simple way of cleaning beneath and around large items.

Various attempts have been made to solve the above-mentioned problems, such as those found in U.S. Pat. Nos. 2007/0209154; 4,715,088; 5,533,230; 5,184,371; 6,921,438; and 4,506,406. This prior art is representative of attachments for vacuum cleaner hoses. None of the above inventions and patents, taken either singly or in combination, is seen to describe the invention as claimed.

Ideally, an attachment for vacuum cleaner hoses should require little maintenance, operate reliably, make it easy to clean beneath and around large bulky items, and be manufactured at a modest expense. Thus, a need exists for a reliable attachment for a vacuum cleaner hose adapted to clean difficult to reach areas so as to avoid the above-mentioned problems.

### BRIEF SUMMARY OF THE INVENTION

In view of the foregoing disadvantages inherent in the known attachments for vacuum cleaner hoses art, the present invention provides a novel vacuum cleaner attachment system. The general purpose of the present invention, which will be described subsequently in greater detail, is to provide an attachment for a vacuum cleaner hose adapted to clean inaccessible areas.

A vacuum cleaner attachment is disclosed herein comprising an upper tubular elongated hollow member having a first open end and a second open end, a connector, and a lower elongated hollow member having a first end and a second end, the first end adapted to fit the connector.

The first open end of the upper tubular elongated hollow member is adapted to connect to an end of a vacuum cleaner hose connected to a vacuum cleaner and the second open end is adapted to connect to the connector. The connector connects the upper tubular elongated hollow member and the lower elongated hollow member and comprises an articulated swivel connector which allows a fluid transition through a wide array of angles between the upper tubular elongated hollow member and the lower elongated hollow member.

The lower elongated hollow member comprises an elongated flattened rectangular profile having a bottom surface and a top surface, the bottom surface located adjacent a floor surface when a user is operating the vacuum cleaner. The lower elongated hollow member comprises at least one slot-like debris intake opening along the second end of the lower elongated hollow member suitable to accept debris from the floor surface. The upper tubular elongated hollow member, the connector, and the lower elongated hollow member form a vacuum attachment assembly.

A kit is also described herein including at least one vacuum attachment assembly comprising at least one upper tubular elongated hollow member, at least one connector, at least one lower elongated hollow member, and at least one exchangeable end attachment.

A preferred method of use is further disclosed herein comprising the following steps: attaching a first open end of an upper tubular elongated hollow member to the end of a vacuum cleaner hose, attaching a second open end of the upper tubular elongated hollow member to a connector, attaching a first end of a lower elongated hollow member comprising an elongated flattened rectangular profile, a bottom surface and a top surface, the bottom surface comprising debris intake openings, to the connector, and vacuum-cleaning underneath furniture while maintaining an upright position.

The present invention holds significant improvements and serves as a vacuum cleaner attachment system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Shirley's Solutions Systems, constructed and operative according to the teachings of the present invention.

FIG. 1 shows a perspective view illustrating a vacuum cleaner attachment according to an embodiment of the present invention.

FIG. 2 is a perspective view illustrating the vacuum cleaner attachment in an in-use condition according to an embodiment of the present invention of FIG. 1.

FIGS. 3A and 3B are perspective views illustrating various embodiments of an exchangeable end attachment.

FIG. 4 is a flowchart illustrating a method of use according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a vacuum cleaner attachment device and more particularly to an attachment for a vacuum cleaner hose adapted to clean inaccessible areas.

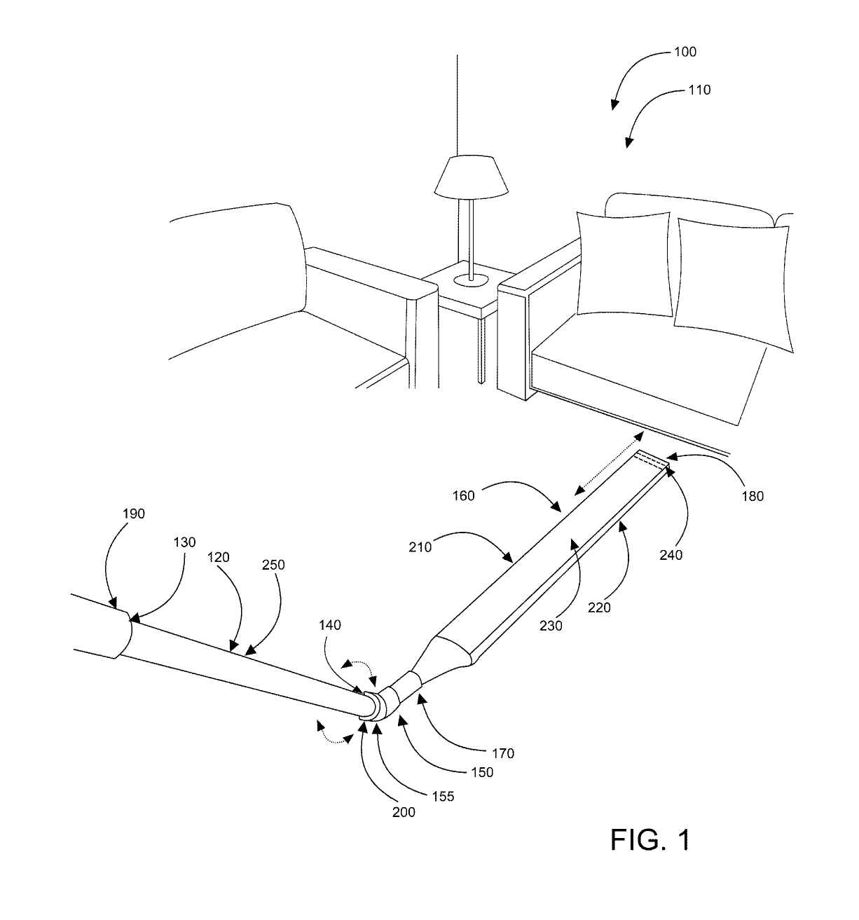

Referring to the drawings by numerals of reference there is shown in FIG. 1, a perspective view illustrating vacuum cleaner attachment 110 according to an embodiment of the present invention.

Shirley's Solutions Systems 100 preferably comprises vacuum cleaner attachment 110 comprising upper tubular elongated hollow member 120 having first open end 130 and second open end 140, connector 150, and lower elongated hollow member 160 having first end 170 and second end 180.

Upper tubular elongated hollow member 120 preferably comprises first plastic pipe 250. First plastic pipe 250 preferably measures 1 inch in diameter and 36 inches in length. However, it should be appreciated that other heights and diameters will fall within the scope and spirit of the invention as described herein, and that any references to sizes, heights, and weights are exemplary, and are not to be construed as limiting in any way. Upper tubular elongated hollow member 120 is preferably made of PVC. However, upper tubular elongated hollow member 120 may comprise any suitable material, such as any plastic material or rubber. Upper tubular elongated hollow member 120 comprises first open end 130 and second open end 140. First open end 130 of upper tubular elongated hollow member 120 is adapted to connect to end of a vacuum cleaner hose 190, which in turn is connected to a vacuum cleaner, and second open end 140 is adapted to connect to connector 150.

First open end 130 preferably is slightly smaller in diameter than end of vacuum cleaner hose 190 so that end of vacuum cleaner hose 190 receives first open end 130 in a tight fitting manner. First open end 130 may alternatively be suitably shaped to fit over end of vacuum cleaner hose 190 in a tight fitting manner. Connector 150 may receive therein second open end 140, as a tight fit, or alternatively second open end 140 may be adapted to receive connector 150 as a tight fit.

Connector 150 preferably comprises elbow attachment 200 and connects upper tubular elongated hollow member 120 and lower elongated hollow member 160. Elbow attachment 200 may preferably comprise a 45 or 65 degree elbow attachment 200. 45 or 65 degree elbow attachment 200 may connect upper tubular elongated hollow member 120 and lower elongated hollow member 160 in such a manner that vacuum cleaner attachment 110 comprises an angled profile. The angled profile of vacuum cleaner attachment 110 allows user 320 to stand in an upright position and vacuum clean a floor surface underneath or around large items. Alternatively, connector 150 may comprise an articulated swivel connector 155 which allows a fluid transition through a wide array of angles between upper tubular elongated hollow member 120 and lower elongated hollow member 160.

Lower elongated hollow member 160 comprises elongated flattened rectangular profile 210 having bottom surface 220 and top surface 230. Bottom surface 220 is located adjacent a floor surface when user 320 is operating the vacuum cleaner. Lower elongated hollow member 160 is preferably made of plastic and may preferably measure 36 inches in length, 6 inches in width, and 1.5 inches in height. Due to elongated flattened rectangular profile 210, lower elongated hollow member 160 provides easy access to hard to reach areas and makes it easy to navigate vacuum cleaner attachment 110 underneath couches, beds, and other furniture.

Lower elongated hollow member 160 preferably comprises at least one debris intake opening 240 suitable to accept debris from floor surface. Debris intake opening 240 preferably is located on bottom surface 220. Debris intake opening 240 preferably comprises at least one slot-like opening along second end 180 of lower elongated hollow member 160. Alternatively, debris intake opening 240 may comprise at least one slot-like elongated opening along the longitudinal axis of lower elongated hollow member 160 or at least one slot-like opening perpendicular to the longitudinal axis of lower elongated hollow member 160. Debris intake opening(s) 240 may comprise any suitable shape and any suitable number of openings.

Lower elongated hollow member 160 comprises first end 170 which is adapted to fit connector 150. First end 170 preferably is slightly smaller in diameter than connector 150 so that connector 150 receives first end 170 in a tight fitting manner. First end 170 may alternatively be suitably shaped to fit over connector 150 in a tight fitting manner. Connector 150 therefore connects upper tubular elongated hollow member 120 and lower elongated hollow member 160 and creates and angle which allows user 320 to stand in an upright position while vacuum cleaning.

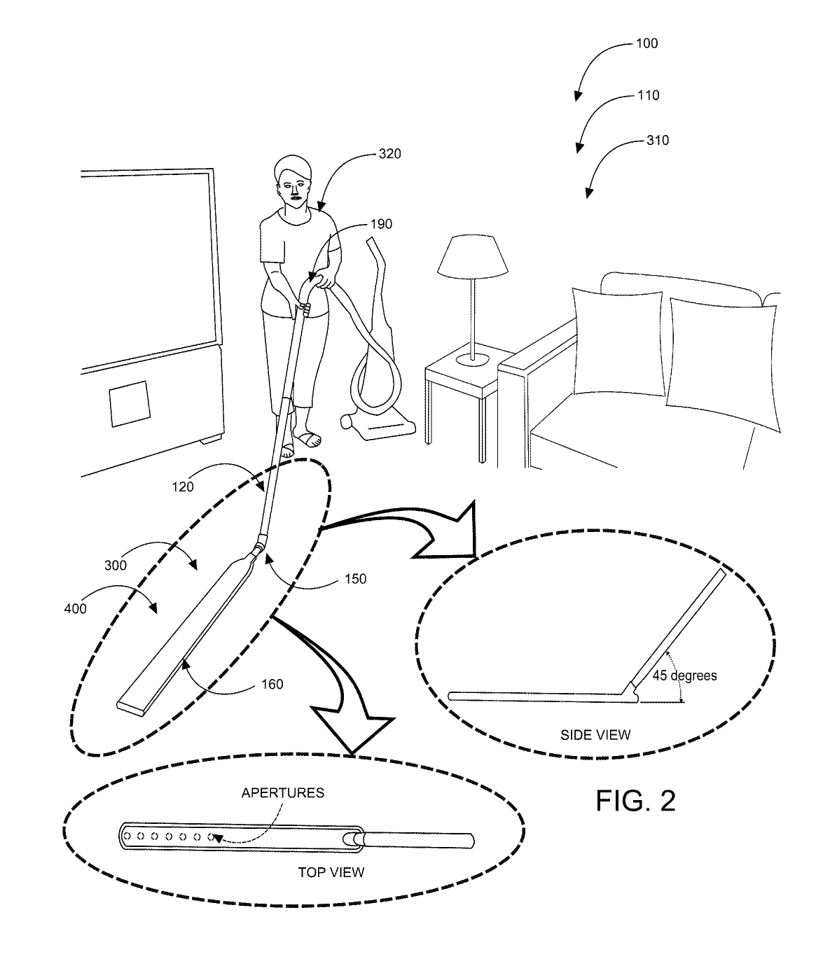

Referring now to FIG. 2, a perspective view illustrating the vacuum cleaner attachment 110 in an in-use condition 310 according to an embodiment of the present invention of FIG. 1.

Upper tubular elongated hollow member 120, connector 150, and lower elongated hollow member 160 preferably form vacuum attachment assembly 300. Therefore user 320 may connect upper tubular elongated hollow member 120, connector 150, and lower elongated hollow member 160 so as to assemble vacuum cleaner attachment 110. After connecting vacuum cleaner attachment 110 to vacuum cleaner hose, user 320 may hold end of vacuum cleaner hose 190 and upper tubular elongated hollow member 120 and move lower elongated hollow member 160 across floor surface so as to create in-use condition 310.

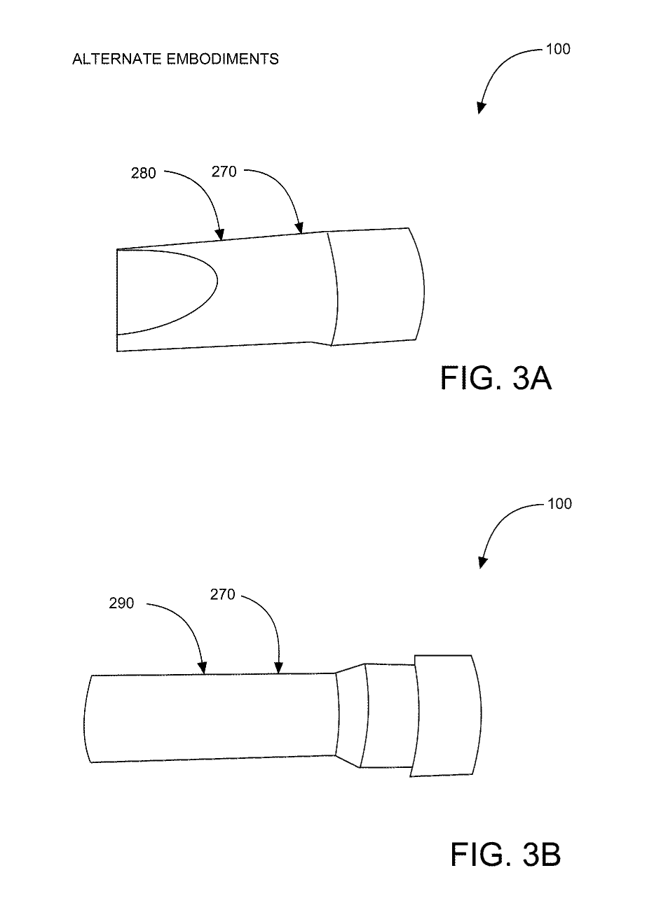

Referring now to FIGS. 3A and 3B, perspective views illustrating various embodiments of exchangeable end attachment 270.

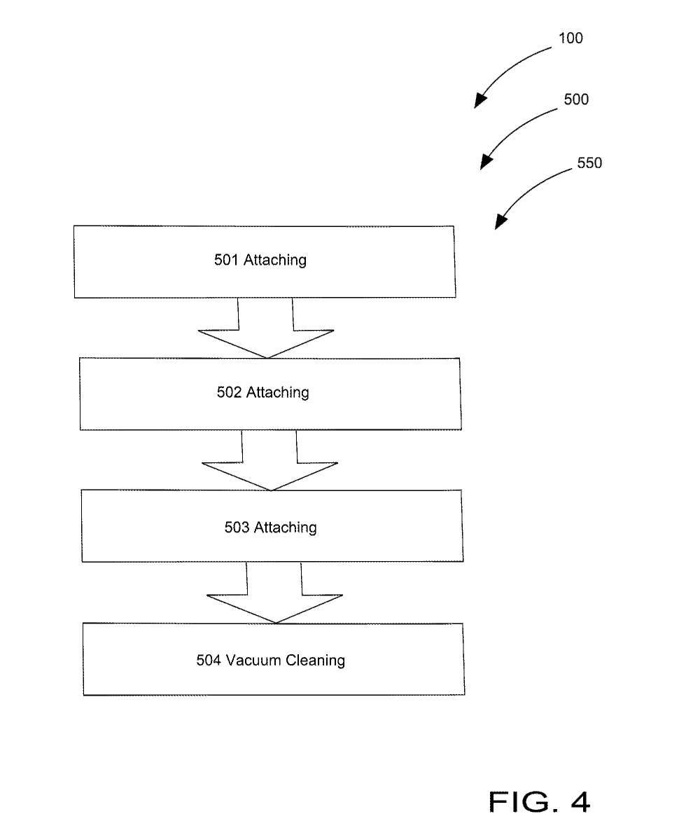

In an alternative embodiment lower elongated hollow member 160 comprises a second plastic pipe. The second plastic pipe preferably measures 1 inch in diameter and 36 inches in length and is adapted to connect to connector 150 and to exchangeable end attachment 270. Exchangeable end attachment 270 preferably comprises squashed-end pipe 280 or rounded-end pipe 290 as shown in FIG. 4A and FIG. 4B. Exchangeable end attachment 270 may comprise various vacuum cleaner attachments such as brushes, tapered attachments, etc.

In another alternative embodiment, upper tubular elongated hollow member 120, connector 150, and lower elongated hollow member 160 may be made of a single piece construction which preferably comprises an angled profile. Shirley's Solutions Systems 100 may further be manufactured in various sizes suitable for different situations. Shirley's Solutions Systems 100 may comprise a small version suitable for use in vehicles or campers and a medium size version for use in close-quartered spaces, small rooms etc.

Shirley's Solutions Systems 100 may be sold as kit 400 comprising a vacuum attachment assembly 300 comprising the following parts: at least one upper tubular elongated hollow member 120, at least one connector 150, at least one lower elongated hollow member 160, at least one exchangeable end attachment 270, and at least one set of user instructions.

Shirley's Solutions Systems 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

Referring now to FIG. 4, a flowchart 550 illustrating a method of use 500 according to an embodiment of the present invention of FIG. 1.

In accordance with the embodiments of the present invention, a preferred method of use 500 is disclosed herein comprising: step one 501 attaching first open end 130 of upper tubular elongated hollow member 120 to end of a vacuum cleaner hose 190, step two 502 attaching second open end 140 of upper tubular elongated hollow member 120 to elbow connector 150, step three 503 attaching first end 170 of lower elongated hollow member 160 comprising elongated flattened rectangular profile 210, bottom surface 220 and top surface 230, bottom surface 220 comprising debris intake opening(s) 240, to elbow connector 150, and step four 504 vacuum-cleaning underneath furniture while maintaining an upright position.

It should be noted that the steps described in the method of use 500 can be carried out in many different orders, in accordance with user preference. Upon reading this specification, it should be appreciated that, under appropriate circumstances, considering such issues as design preference, user preferences, marketing preferences, cost, structural requirements, available materials, technological advances, etc., other methods of use arrangements, for example, different orders within above-mentioned list, elimination or addition of certain steps, including or excluding certain maintenance steps, etc., may be sufficient.

The embodiments of the invention described herein are exemplary and numerous modifications, variations and rearrangements can readily be envisioned to achieve substantially equivalent results, all of which are intended to be embraced within the spirit and scope of the invention. Furthermore, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection, the nature and essence of the technical disclosure of the application.

What is claimed is new and desired to be protected by Letters Patent is set forth in the appended claims:

1. A vacuum cleaner attachment comprising:
an upper tubular elongated hollow member having a first open end and a second open end;
a connector; and
a lower elongated hollow member having a first end and a second end, said first end adapted to fit said connector;
wherein said first open end of said upper tubular elongated hollow member is adapted to connect to an end of a vacuum cleaner hose connected to a vacuum cleaner and said second open end is adapted to connect to said connector;
wherein said connector comprises an elbow attachment and connects said upper tubular elongated hollow member and said lower elongated hollow member;
wherein said lower elongated hollow member comprises an elongated flattened rectangular profile having a bottom surface and a top surface, said bottom surface located adjacent a floor surface when a user is operating said vacuum cleaner; and
wherein said lower elongated hollow member comprises at least one debris intake opening suitable to accept debris from said floor surface.

2. The vacuum cleaner attachment of claim 1 wherein said upper tubular elongated hollow member comprises a first plastic pipe.

3. The vacuum cleaner attachment of claim 1 wherein said connector comprises a 22.5 degree elbow attachment.

4. The vacuum cleaner attachment of claim 1 wherein said connector comprises a 45 degree elbow attachment.

5. The vacuum cleaner attachment of claim 1 wherein said connector comprises a 60 degree elbow attachment.

6. The vacuum cleaner attachment of claim 1 wherein said connector comprises an articulated swivel connector which allows a fluid transition through a wide array of angles between said upper tubular elongated hollow member and said lower elongated hollow member.

7. The vacuum cleaner attachment of claim 1 wherein said lower elongated hollow member comprises a second plastic pipe and said second end of said lower elongated hollow member is adapted to be connected to an exchangeable end attachment.

8. The vacuum cleaner attachment of claim 7 wherein said exchangeable end attachment comprises a squashed-end pipe.

9. The vacuum cleaner attachment of claim 7 wherein said exchangeable end attachment comprises a rounded-end pipe.

10. The vacuum cleaner attachment of claim 1 wherein said lower elongated hollow member comprises said elongated flattened rectangular profile, said bottom surface and said top surface, said bottom surface comprising said debris intake opening(s) comprising at least one slot-like opening along said second end of said lower elongated hollow member.

11. The vacuum cleaner attachment of claim 1 wherein said lower elongated hollow member comprises said elongated flattened rectangular profile, said bottom surface and said top surface, said bottom surface comprising said debris intake opening(s) comprising at least one slot-like elongated opening along the longitudinal axis of said lower elongated hollow member.

12. The vacuum cleaner attachment of claim 1 wherein said lower elongated hollow member comprises said elongated flattened rectangular profile, said bottom surface and said top surface, said bottom surface comprising said debris intake opening(s) comprising at least one slot-like opening perpendicular to said longitudinal axis of said lower elongated hollow member.

13. The vacuum cleaner attachment of claim 1 wherein said upper tubular elongated hollow member, said connector, and said lower elongated hollow member form a vacuum attachment assembly.

14. The vacuum cleaner attachment of claim 1 wherein said upper tubular elongated hollow member, said connector, and said lower elongated hollow member are made of plastic.

15. The vacuum cleaner attachment of claim 14 wherein said upper tubular elongated hollow member, said connector, and said lower elongated hollow member are made of PVC.

16. The vacuum cleaner attachment of claim 1 wherein said upper tubular elongated hollow member, said connector, and said lower elongated hollow member are made of a single piece construction.

17. The vacuum cleaner attachment of claim 16 wherein said single piece construction comprises an angled profile.

18. A vacuum cleaner attachment comprising:
an upper tubular elongated hollow member having a first open end and a second open end;
a connector; and
a lower elongated hollow member having a first end and a second end, said first end adapted to fit said connector;
wherein said first open end of said upper tubular elongated hollow member is adapted to connect to an end of a vacuum cleaner hose connected to a vacuum cleaner and said second open end is adapted to connect to said connector;
wherein said connector connects said upper tubular elongated hollow member and said lower elongated hollow member and comprises an articulated swivel connector which allows a fluid transition through a wide array of angles between said upper tubular elongated hollow member and said lower elongated hollow member;
wherein said lower elongated hollow member comprises an elongated flattened rectangular profile having a bottom surface and a top surface, said bottom surface located adjacent a floor surface when a user is operating said vacuum cleaner;
wherein said lower elongated hollow member comprises at least one slot-like debris intake opening along said second end of said lower elongated hollow member suitable to accept debris from said floor surface; and
wherein said upper tubular elongated hollow member, said connector, and said lower elongated hollow member form a vacuum attachment assembly.

19. The vacuum cleaner attachment of claim 18 further comprising a kit including said vacuum attachment assembly comprising said upper tubular elongated hollow member, said connector, said lower elongated hollow member, and a multitude of said exchangeable end attachments.

20. A method comprising the steps of:
attaching a first open end of an upper tubular elongated hollow member to the end of a vacuum cleaner hose;
attaching a second open end of said upper tubular elongated hollow member to an elbow connector;
attaching a first end of a lower elongated hollow member comprising an elongated flattened rectangular shape, a bottom surface and a top surface, said bottom surface comprising debris intake openings, to said elbow connector; and
vacuum-cleaning underneath furniture while maintaining an upright position.
